(19) United States
(12) Patent Application Publication
(10) Pub. No.: US 2013/0164978 A1
(43) Pub. Date: Jun. 27, 2013

(54) CONNECTOR WITH DECREASED ELECTROMAGNETIC RADIATION EMMISSION

(71) Applicants: JIAN-WEI LUO, Shenzhen City (CN); JUN-WEI WANG, Shenzhen City (CN)

(72) Inventors: JIAN-WEI LUO, Shenzhen City (CN); JUN-WEI WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/566,035

(22) Filed: Aug. 3, 2012

(30) Foreign Application Priority Data
Dec. 22, 2011 (CN) 201110435103.7

(51) Int. Cl. H01R 13/648

(52) U.S. Cl. 439/607.01

(57) ABSTRACT

A connector includes a connector receptacle and a cable. The connector receptacle includes an insulating body, a metallic box and a magnetic ring. The metallic box is connected to the insulating body and defines a closed receiving cavity. The cable includes a cable head. The cable head is received in the receiving cavity, and extends through the magnetic ring.

### BACKGROUND

1. Technical Field

The disclosure generally relates to a connector which is electronically connected to a port of an electronic apparatus.

2. Description of the Related Art

Hard disks in computer servers usually adopt a serial advance technology attachment (SATA) port. A cable and a connector at one end of the cable are used for electronically connecting the SATA port. During the testing of radiation emission in the computer servers, the electromagnetic radiation easily emits from the connector and the cable, greatly affecting the radiation emission value of the computer servers.

Therefore, there is room for improvement within the art.

### BRIEF DESCRIPTION OF THE DRAWINGS

Many aspects of an exemplary connector can be better understood with reference to the following drawings. The components in the drawings are not necessarily drawn to scale, the emphasis instead being placed upon clearly illustrating the principles of the exemplary connector. Moreover, in the drawings, like reference numerals designate corresponding parts throughout the several views. Wherever possible, the same reference numbers are used throughout the drawings to refer to the same or like elements of an embodiment.

FIG. 1 is a schematic view of a connector according to an exemplary embodiment.

FIG. 2 is an internal schematic view of the connector omitting a portion of a metallic box.

### DETAILED DESCRIPTION

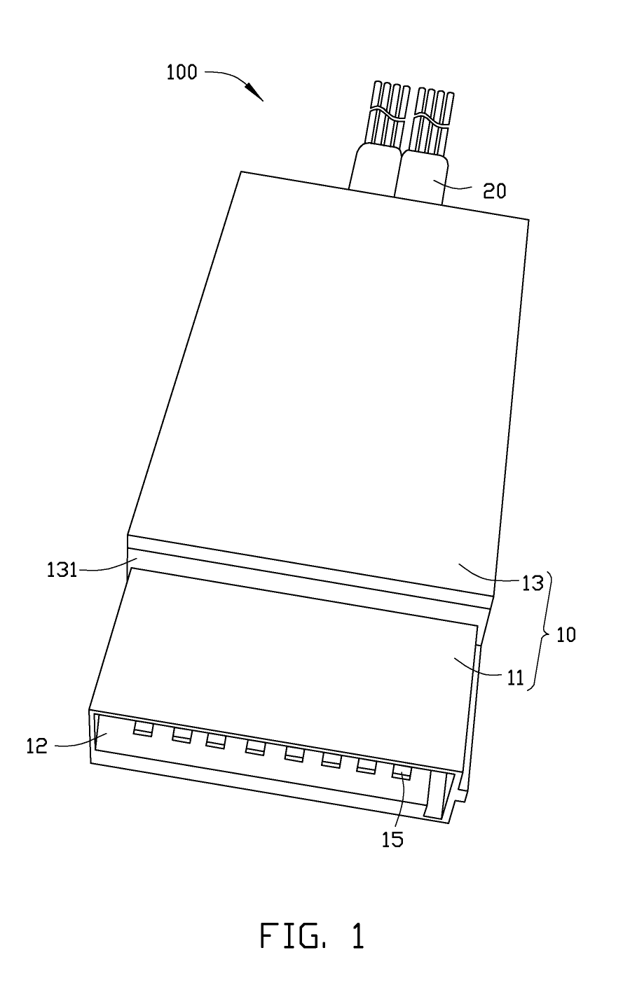

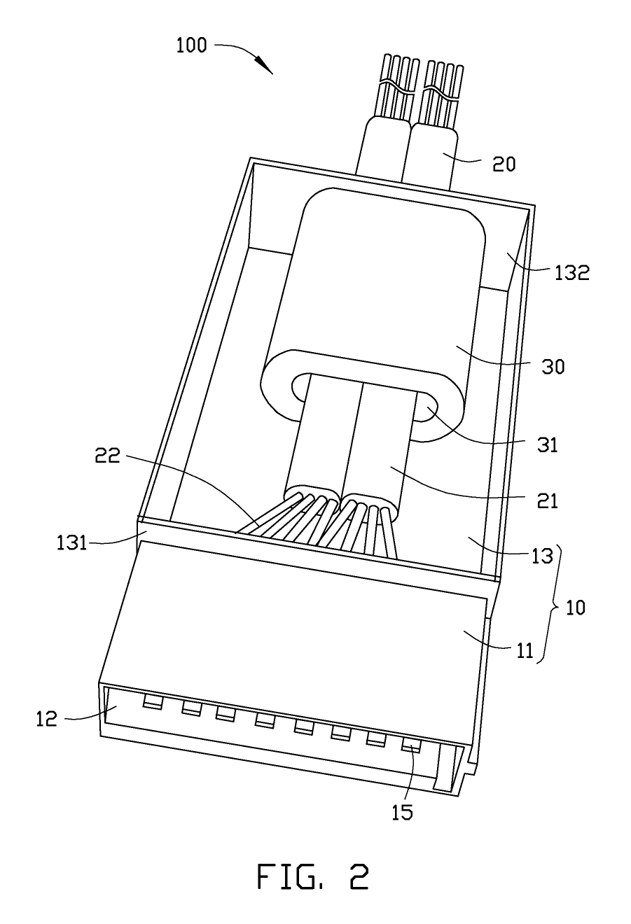

Referring to FIGS. 1 and 2, a connector 100 is used for connection with a port of a storage apparatus such as a hard disk (not shown). The connector 100 is configured for inserting into the port to form an electrical connection in data communication or telecommunication applications.

The connector 100 includes a connector receptacle 10 and a cable 20. The connector receptacle 10 includes an insulating body 11, a metallic box 13, and a magnetic ring 30.

The insulating body 11 is formed at one end of the connector receptacle 10. In the exemplary embodiment, the insulating body 11 is made of plastics. The insulating body defines a chamber 12. A plurality of conductive contacts 15 are positioned in the chamber 12 for electronically connecting a port of a storage apparatus.

The metallic box 13 is formed at another end of the connector receptacle 10 and is connected to the insulating body 11. Because the metallic box 13 is made of metal, the metallic box 13 can shield most of electromagnetic radiation which is produced by the connector 100. The metallic box 13 is substantially a closed hollow box, and defines a closed receiving cavity 130 therein. The metallic box 13 includes a first end 131 and a second end 132. The first end 131 is connected to the insulating body 11.

The cable 20 includes an insulating sleeve 21 and a cable head 22. The insulating sleeve 21 is made of insulating plastic, and enfolds the cable head 22. The cable head 22 and the insulating sleeve 21 are partially received in the receiving cavity 130. One end of the cable head 22 is electrically connected to the contacts 15 through the first end 131, and another end of the cable head 22 extends out of the second end 132 from the receiving cavity 130.

The magnetic ring 30 is made of ferromagnetic material. The magnetic ring 30 is received in the receiving cavity 130 of the metallic box 13, and is secured to the second end 132 of the metallic box. The cable head 22 with the insulating sleeve 21 extends through the magnetic ring 30. The magnetic ring 30 has impedance characteristics, and can inhibit more electromagnetic radiation production in the cable head 22.

In order to assemble the magnetic ring 30 in the metallic box 13, top or down portions of the metallic box 13 need to be exposed. After the magnetic ring 30 is assembled in the receiving cavity 130, the top or down portion of the metallic box 13 is welded to the metallic box 13, thereby forming a closed structure. The magnetic ring 30 and the metallic box 13 effectively prevent more electromagnetic radiation emission form the connector 100.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A connector comprising:
a connector receptacle including an insulating body, a metallic box and a magnetic ring, the metallic box connected to the insulating body and defining a closed receiving cavity; and
a cable including a cable head, the cable head received in the receiving cavity, and extending through the magnetic ring.

2. The connector as claimed in claim 1, wherein the insulating body is made of plastics, and defines a chamber, and a plurality of conductive contacts are positioned in the chamber for connecting one end of the cable head.

3. The connector as claimed in claim 2, wherein the metallic box includes a first end and a second end, the first end is connected to the insulating body 11, and the magnetic ring is secured to the second end.

4. The connector as claimed in claim 1, wherein the cable includes an insulating sleeve, the insulating sleeve embraces the cable head and extends through the magnetic ring, the insulating sleeve is partially received in the receiving cavity.

5. The connector as claimed in claim 1, wherein the magnetic ring is made of ferromagnetic material.
